(19) United States
(12) Patent Application Publication
(10) Pub. No.: US 2017/0348835 A1
(43) Pub. Date: Dec. 7, 2017

(54) ELECTRIC TORQUE TOOL WITH RAMPING EFFECT

(71) Applicant: Actuant Corporation, Menomonee Falls, WI (US)

(72) Inventors: Jeffrey Gerard Skelly, Sun Prairie, WI (US); George T. Prince, Sussex, WI (US); Rodolfo Favian Gomez, Lancaster, PA (US); Richard Carlton Steinfeldt, Waunakee, WI (US); Mark Alexander Johnson, Bayside, WI (US); Christopher John Kolbe, Muskego, WI (US)

(21) Appl. No.: 15/170,603

(22) Filed: Jun. 1, 2016

(51) Int. Cl. B25B 23/147; B25B 21/00; B25B 23/00

(52) U.S. Cl. CPC B25B 23/147; B25B 21/008; B25B 23/0078

(57) ABSTRACT

A torque fastening system and method for applying torque to secure a fastener, includes actuating a torque tool to provide an initial command torque value to the servo drive of an electric motor for applying torque to a fastener. The initial command torque value is less than a target command torque value corresponding to a desired maximum target torque value entered by an operator. The torque fastening system operates at the initial command torque value to rotate a threaded fastener. Thereafter, in response to a spike in torque that corresponds to a decrease in motor speed, the torque tool output changes from the initial command torque value to a jump command torque value having a greater power value to increase torque applied by the torque tool to a fastener. The command torque value is ramped from the jump command torque value toward the target command torque value to increase the torque provided by the torque tool.

### BACKGROUND

There are various methods and devices for controlling torque provided by a powered tool for tightening a fastener.

### SUMMARY

Many existing methods and devices for controlling a torque tool to apply a desired amount of torque to a threaded fastener are imprecise. Few if any of such methods and devices reduce the likelihood of applying excessive torque to a threaded fastener. In one embodiment, the invention avoids overshoot of torque when a fastener completes threading and the fastener suddenly contacts the surface of a bolt, flange or other receiving element. If not controlled, such contact causes a sudden spike or increase in torque output by a tool beyond the ratings for the tool and/or the fastener.

One embodiment provides a method for applying torque for securing a fastener with a torque tool. The method includes determining an initial command torque value for outputting torque to a fastener engaged by the torque tool that is less than a target command torque value and, in response to actuation of the torque tool, operating the torque tool at the initial command torque value. The method further includes, in response to a spike in torque, increasing from the initial command torque value to a jump command torque value to increase torque output by the torque tool, and ramping from the jump command torque value toward the target command torque value to increase torque output by the torque tool.

Another embodiment provides an electric torque fastening system. The system includes a torque tool including an actuator, an electric motor and a motor speed sensor, and a controller for controlling power to the electric motor. The controller is configured to, upon actuation of the torque tool by the actuator, provide an initial command torque value for providing power to the electric motor to apply torque to a fastener engaged with the torque tool. In response to a spike in torque, the controller is configured to provide a jump command torque value that is greater than the initial command torque value to increase electrical power to the electric motor and increase torque output by the torque tool, and to subsequently provide a ramping increase from the jump command torque value toward a target command torque value to increase the electrical power provided to the electric motor and thus the torque output by the torque tool.

Another embodiment provides a method for applying torque for securing a fastener with a torque tool. The method includes, in response to a target torque value, determining an initial command torque value, a jump command torque value, and a target command torque value. In response to actuation of the torque tool, the method operates the torque tool at the initial command torque value and, in response to a spike in torque, essentially instantaneously increases from the initial command torque value to the jump command torque value to increase torque output by the torque tool. Thereafter, the method ramps from the jump command torque value toward the target command torque value to increase torque output by the torque tool.

Other aspects and embodiments will become apparent by consideration of the detailed description and accompanying drawings.

### BRIEF DESCRIPTION OF THE DRAWINGS

FIG. 1 is a perspective view of a torque tool according to one embodiment.

FIG. 2 is a rear view of the torque tool that includes a control panel.

FIG. 3 is a perspective view of a torque fastening system that includes the torque tool.

FIG. 4 is a block diagram of the torque fastening system.

FIG. 5 is a flow chart of a ramping routine for the torque fastening system.

FIG. 6 is a graph showing one example of an operation of the ramping routine.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

As should also be apparent to one of ordinary skill in the art, the systems shown in the figures are models of what actual systems might be like. Many of the modules and logical structures described are capable of being implemented in software executed by a microprocessor or a similar device or of being implemented in hardware using a variety of components including, for example, application specific integrated circuits (“ASICs”). Terms like “processor” and “controller” may include or refer to both hardware and/or software. The term “memory” may include or refer to volatile memory, non-volatile memory, or a combination thereof and, in various constructions, may also store operating system software, applications/instructions data, and combinations thereof.

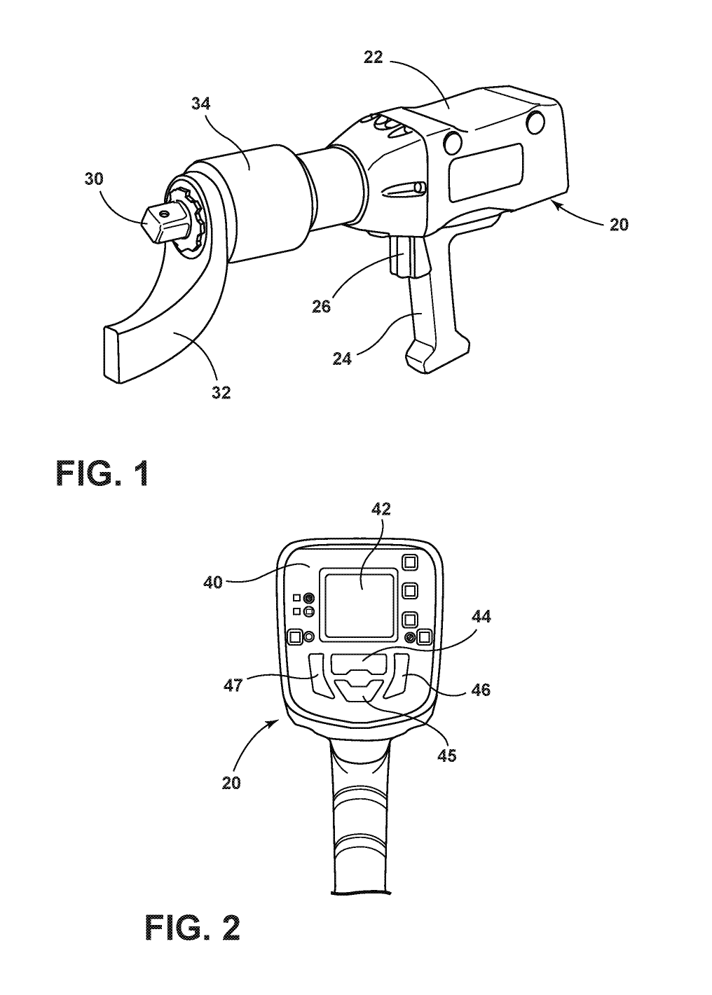

FIG. 1 illustrates an example of a torque tool 20. The torque tool 20 includes a body 22, a hand grip 24 and an actuator 26, such as a trigger. The torque tool 20 includes a fastener receiver 30 shaped to receive an adaptor and engage a threaded fastener. The torque tool 20 has a reaction arm 32 disposed at a front end so a user can maintain the position in use. The torque tool 20 includes a planetary torque gearbox disposed within a front housing 34 that provides torque generated by an electric motor disposed within the torque tool to rotate the fastener receiver 30.

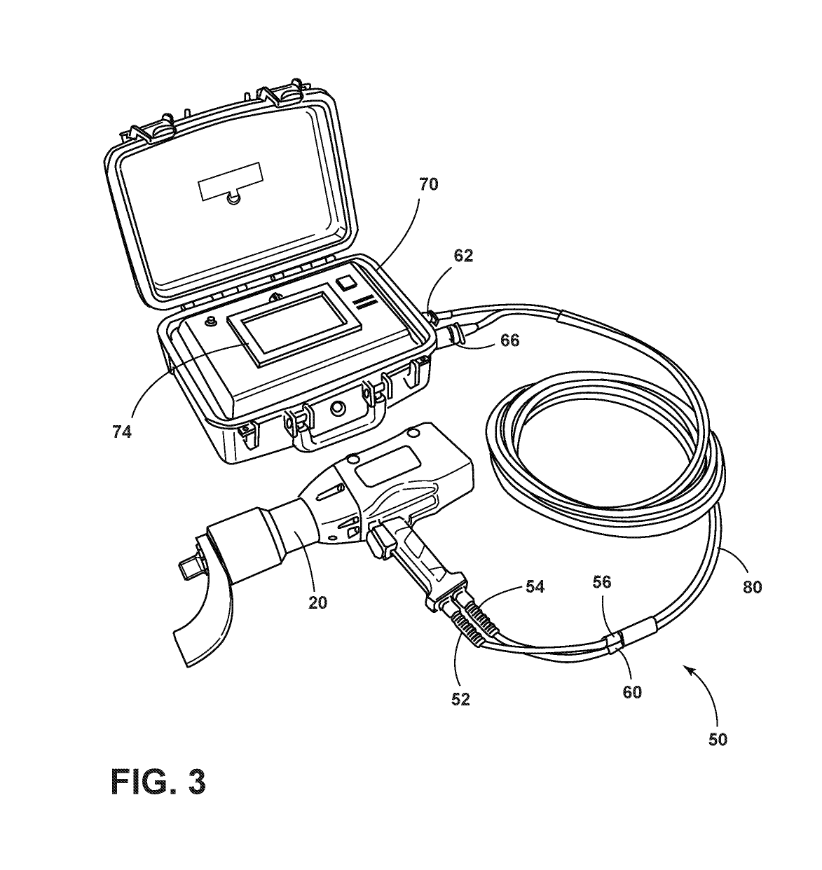

FIG. 2 shows a torque tool control panel 40 having a display 42 (for example, an LED display) that is disposed at a rear end of the torque tool 20. Push buttons 44-47 (for example, pressure sensing switches) on the torque tool control panel 40 receive user inputs and provide visual confirmation for the inputs and conditions of the torque tool 20. The push buttons 44, 45 act as up down buttons in some setting operations. In other embodiments, other input devices may be used, for example, icons on a touch screen. The actuator 26 acts as an input for setting a mode or condition in some situations.

FIG. 3 shows an electric torque fastening system 50 that includes the torque tool 20. In the example illustrated, the electric torque fastening system 50 includes a power connecting jack 52 and a communication connecting jack 54, that are each connected to a lower end of the hand grip 24 of the torque tool 20. The power connecting jack 52 electrically connects a power connector 56 to the torque tool 20. The communication connecting jack 54 electrically connects a communication connector 60 to the torque tool 20. A second end of the power connector 56 includes a power jack 62 and a second end of the communication connector 60 includes a communication jack 66. A control unit 70 includes ports that receive the power jack 62 and the communication jack 66. The control unit 70 includes a control unit input interface/display 74 (for example a touchscreen) for receiving inputs from a user and displaying information. A connector sheath 80 protects the power connector 56 and the communication connector 60 by acting as a single cable for the connectors 56, 60.

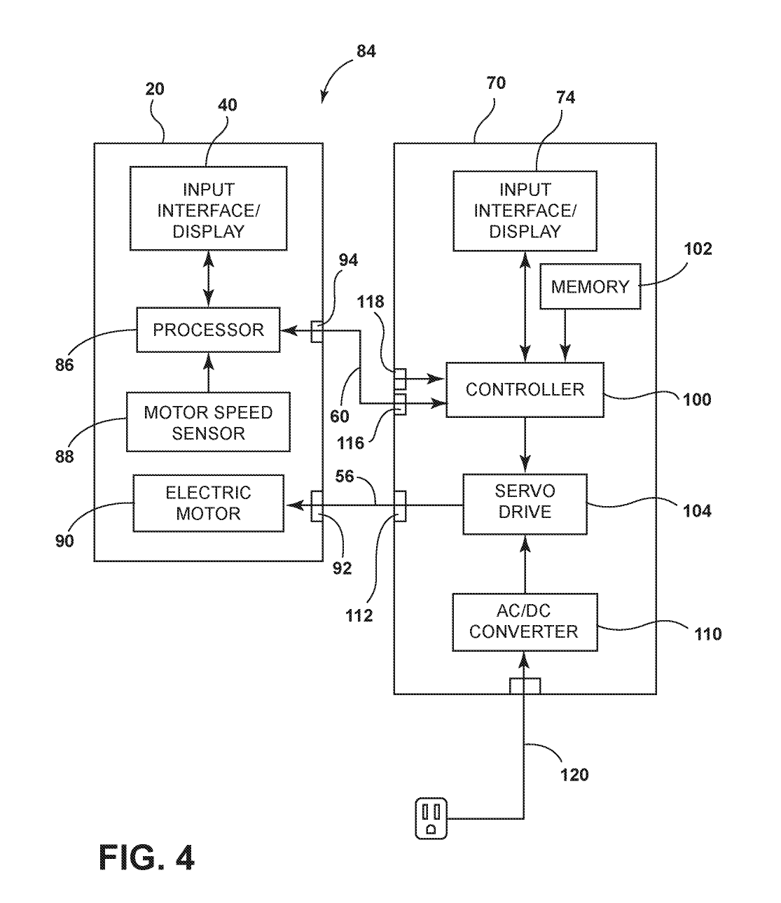

FIG. 4 is a block diagram 84 of the components of the electric torque fastening system 50. The components of the torque tool 20 include the torque tool control panel 40, a processor 86 provided with a circuit board, a motor speed sensor 88 (for example an encoder) and an electric motor 90. The torque tool 20 includes a power port 92 and a communication port 94 disposed in the outer end of the hand grip 24 that receive the power connecting jack 52 and the communication connecting jack 54, respectively.

Components of the control unit 70 shown in FIG. 4 include the control unit input interface/display 74, a controller 100 that includes a memory 102, a servo drive 104, and an AC/DC power convertor 110. Further, the control unit 70 includes a power port 112 that receives the power jack 62 and a communication port 116 that receives the communication jack 66. Further, a port 118 (for example, a USB port) is provided for downloading or uploading data to and from memory 102 to and from external devices. Finally, an outlet connector 120 is provided for connecting the AC/DC power convertor 110 of the control unit 70 to a power source, such as a wall outlet. The AC/DC power convertor 110 converts AC power to DC power.

Set-Up

In the example illustrated, depending on the capabilities of a torque tool 20 and a control unit 70, a gear box selection is made by a user or operator that utilizes the push buttons 44-47 to select between 1000, 2000, 3000 and 6000 maximum foot-pounds for the torque tool. Further, a user also selects between a 115 volt and a 230 volt external power supply for the electric torque fastening system 50. The controller 100 of the control unit 70 is programmable and configured to store the inputs in memory 102 and utilize the inputs to prepare the electric torque fastening system 50 for operation. Thus, the capabilities or operating values for the specific torque tool 20 and the corresponding control unit 70 are set. The capabilities are set forth in a table of values for a specific torque tool having the selected gear box and the specific power supply. For example, a program or routine for providing look up tables of the specific torques, power supply values, and gear boxes is downloaded to memory 102 of the electric torque fastening system 50. The selections of the gear box and the external power supply value result in a selection of specific tables for the specific torque tool 20. Upon this programming, the torque tool 20 is now configured to operate with the maximum torque value and the power supply voltage as selected. Thus, inputs selecting the gearbox or the power supply no longer occur as the electric torque fastening system 50 has been set.

Initially a user inputs a target torque value and angle of rotation or turn for one or a group of fasteners using one of the torque tool control panel 40 and the control unit input interface/display 74. For instance, a user may enter or select a desired target torque value, angle of rotation, and number of fasteners to be secured into the torque tool control panel 40 of the torque tool 20. Alternatively, the information is entered into the control unit input interface/display 74 of the control unit 70. The controller 100 of the control unit 70 processes the inputs. The target torque value corresponds to a target command torque value determined by the controller 100 to provide to the servo drive 104. The controller 100 also is configured to store in memory 102 various percentages of the command target torque value to apply at start-up of the torque fastening system. Further, values for a jump or increase in torque in response to a torque spike are calculated, predetermined and/or pre-stored for a given target torque value. Further, the amount of increase in ramping over time from the jump command torque value to obtain the target command torque value is also stored. Thus, for various torque tools, fasteners and usage, values for a selected target torque applied to a fastener are preset or otherwise stored.

More specifically, a target command torque value, a jump command torque value, an initial command torque value, and a ramp speed are determined based on gearbox size, the target torque value input by an operator, and the power supply value (115 or 230 volts) for the electric torque fastening system 50. The selected lookup table is used to define the ramp speed and other values. The lookup tables have five torque set-points (20%, 40%, 60%, 80% and 100% of full load) The ramping rate or ramping speed is determined from interpolation. The initial command torque value is not less than a minimum value regardless of the inputs.

The torque tool control panel 40 and the control unit input interface/display 74 also are also both operable to selectively change the direction of rotation of the fastener receiver 30 and perform other operations, such as downloading information from the port 118.

After, the electric torque fastening system 50 is programmed or otherwise set-up to operate, when the actuator 26 of the torque tool 20 is actuated to tighten a fastener, operation of a routine or program for securing a fastener begins.

Operation

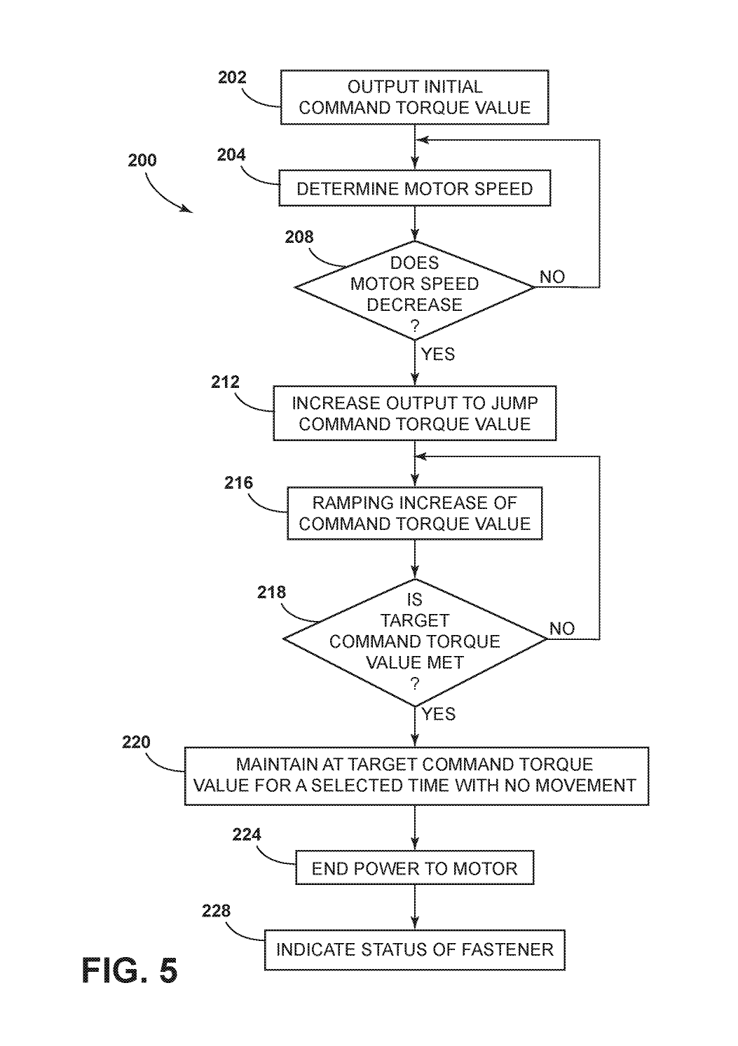

FIG. 5 is a flowchart of an exemplary routine 200 or program for the controller 100 to execute a power ramping algorithm to secure a fastener upon actuation of the actuator 26. Upon actuation, the communication connector 60 transmits an actuation signal, and in some instances other communication signals, between the processor 86 of the torque tool 20 and the controller 100 of the control unit 70.

Initially, the controller 100 is configured to provide an initial command torque value to the servo drive 104, which provides electrical power to the electric motor 90 to provide a corresponding torque value to a fastener (step 202) shown in FIG. 5. The initial command torque value (for example 20% of full load) is preselected or determined to achieve a maximum speed of rotation for the fastener receiver 30 under low torque/load conditions and to avoid an output of excessive torque when the load provided by the fastener increases. The controller 100 of the control unit 70 is configured to receive a motor speed value from the motor speed sensor 88 of the torque tool 20 (step 204) transmitted via the processor 86 and the communication connector 60.

More specifically, in the example illustrated (step 204), the motor speed sensor 88 is an encoder. The motor speed is provided by the rate over time of output pulses from the encoder. The controller 100 is configured to analyze the pulses output by the encoder (processor 86 in an alternative arrangement). Every time a pulse is detected the time difference from the previous pulse (microseconds) is stored in an array in the memory 102. One hundred time values are stored. When a new pulse is received and stored, the oldest stored time value is erased. The controller saves the last four encoder readings and evaluates the difference in time between the current pulse and the prior pulse. The controller 100 calculates the average of the last four differences. Thus, the arrangement requires at least seven encoder readings after an actuation of the actuator 26 to have a stable output. Successive time differences are compared. As long as the time differences are decreasing, increasing speed is determined. Once at least five consecutive new time readings (for example, ten new time readings) are greater than the previous readings, a slowing speed is determined. Thereafter two additional options are determined as follows to result in a slowing speed. If at least one from the group consisting of 1) the speed difference or decrement is equal to more than 1 second, and 2) the speed decrement detected is 50% or less from the maximum speed recorded (minimum time between pulses), the controller 100 advances to increase the torque output (step 212).

So long as the speed does not decrease, the routine maintains the supply of electrical power and again determines the motor speed (step 204). When the controller 100 determines the decrease in motor speed (step 208), the routine increases the output of the controller 100 to provide a jump command torque value (step 212) to the servo drive 104, which provides a corresponding electrical power value (for example 50% of full load) to the electric motor 90.

As shown in FIG. 5, subsequent to the increase to the jump command torque value, the controller 100 is configured to increase the command torque value from the jump command torque value by incrementally increasing or ramping the command torque value toward the target command torque value over time (step 216) as shown in FIG. 5. The controller 100 is configured to then compare the increased command torque value with the target command torque value (step 218). If the target command torque value is not met, the routine returns and increases the command torque value (step 216). When the target command torque value is met (step 218), the routine advances and the controller 100 is configured to maintain the target command torque value to the servo drive 104 for a predetermined time when no rotational movement of the fastener receiver 30 is detected (step 220). Thereafter, the controller 100 discontinues an output to the servo drive 104, which ends the supply of power to the electric motor 90 (step 224), and thus ends operation of the torque tool 20.

In one embodiment, the controller 100 is configured to then indicate a status of the fastener (step 228). The status of a fastener includes whether the proper torque value was applied to the fastener for the proper time without movement of the fastener receiver 30. Thus, a pass/fail indication is provided and stored for the condition of a mounted fastener.

In an instance wherein the actuator 26 is actuated, but the tool does not move enough to detect a speed decrement or decrease (fastener already tightened), after a predetermined time the controller 100 will advance the routine to the jump command torque value and ramp the command torque value.

### Example

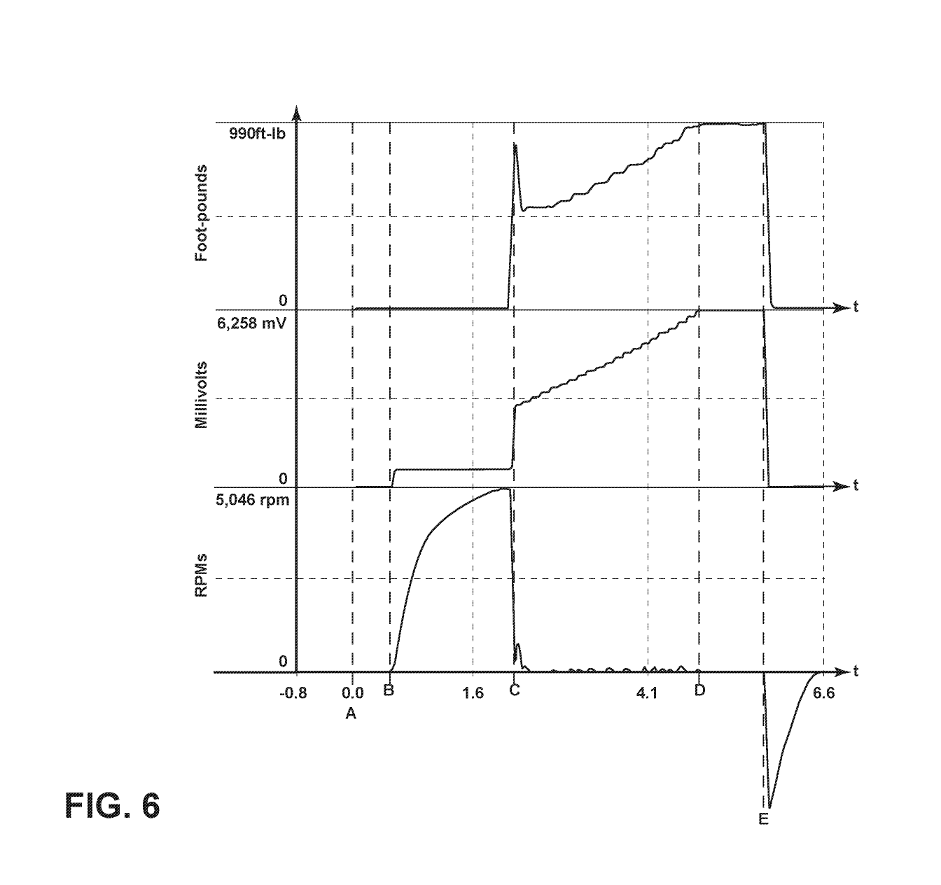

FIG. 6 is a graph with three graph sections that illustrate an example of one method of applying torque with the torque tool 20 to a fastener in accordance with the embodiment of FIG. 5. As shown in FIG. 6, the lowest graph section shows motor speed (revolutions per minute RPMs) over time for the torque tool 20. The middle graph section shows a command torque value in millivolts (mV) over time provided to a servo drive 104. The upper graph section shows torque (ft-lbs) over time for the torque tool 20.

As shown in FIG. 6, at time A (0.0 seconds), the electric torque fastening system 50 is powered up. At time B, the actuator 26 is triggered by a user and an initial command torque value (mV) is provided by the controller 100 to the servo drive 104 as shown in the middle graph section of FIG. 6. Based on the start-up command torque value, the servo drive 104 controls the electrical power received from the AC/DC power convertor 110, that is provided to the electric motor 90. In FIG. 6, during most of the time period B-C, motor speed increases rapidly as, for instance, the torque tool 20 rotatably advances a threaded fastener onto a bolt or the like.

At time C shown in FIG. 6, the threaded fastener begins seating on the face of a bolt. As the fastener seats onto the bolt, further rotation is very limited. Thus, the motor speed falls rapidly at or about the time C as shown in the lower graph section of FIG. 6. The decrease in motor speed (step 208 in FIG. 5) corresponds with an increase in output torque as shown by a spike or large increase in torque as shown in the upper graph section, that occurs concurrently with the decrease in motor speed as shown in the lower graph section of FIG. 6. Thus, the motor speed decrease is a different variable that corresponds with the torque increase. Therefore, sensing the motor speed decrease replaces the need for a torque sensor.

As shown in FIG. 6 at time C, in response to the decrease in motor speed, and thus the concurrent increase in torque, the controller 100 provides a jump command torque value (mV) to the servo drive 104. The jump command torque value is much greater than the initial command torque value. As shown in the middle graph section of FIG. 6, the increase from the initial command torque value to the jump command torque value is an essentially instantaneous increase in the command torque value provided by the controller 100 to the servo drive 104. Thus, the servo drive 104 is configured to receive the jump command torque value from the controller 100 and provide corresponding increased electrical power to the electric motor 90.

Thereafter, as shown in the middle graph of FIG. 6, the command torque value provided to the servo drive 104 is ramped. Consequently, the electrical power provided to the electric motor 90 is increased over time. Ramping of the command torque value generally corresponds to ramping of the torque value provided to a fastener as shown in the upper graph of FIG. 6.

As shown at time D in FIG. 6, the ramped command torque value equals the target command torque value for the particular torque tool 20 and corresponds to the particular torque desired for the particular fastener being mounted. Thus, at time D, the ramping of the command torque value ends, and the target command torque value is applied to the servo drive 104 until a predetermined or preselected time E, with no movement of the fastener receiver 30 of the torque tool 20 occurring. At time E, the target command torque value is deselected by the controller 100, and thus electrical power is no longer output to the electric motor 90 by the servo drive 104. The time segment D-E is determined or preselected to obtain a particular resultant torque value for a set time or portion of a set time, to obtain a properly secured fastener.

By applying an initial command torque value that is less than the target command torque value, a severe spike in torque output by the torque tool 20 onto a fastener that is greater than the target torque value for the system is avoided at time C as shown in FIG. 6. Instead, the spike in torque value remains less than the target torque value for the fastener. Further, the initial command torque value limits operation of the electric motor 90 to a maximum speed that is appropriate for the electric motor. This arrangement is an advantage over other fastening systems, wherein the torque value spikes to a magnitude that may cause damage to a fastener or even to the torque tool 20. Further, such a spike in torque may result in a poorly joined fastener. Jumping to a jump command torque value, that is less than the target command torque value, also ensures that the torque applied by the torque tool 20 does not exceed the desired torque value for the particular fastener.

In one embodiment, the controller 100 is configured for discontinuing the target command torque value so long as rotation of a threaded fastener or movement of the drive of the electric motor 90 does not occur during at least a portion of a set amount of time.

In one embodiment, the ramping from the jump command torque value and toward the target command torque value includes increasing a voltage from the controller 100 to the servo drive 104, such that the servo drive provides electrical power to the electric motor 90 to increase the torque at a rate of between about 100 foot-pounds/second and about 1000 foot-pounds/second.

In one embodiment, the controller 100 is a servo controller for an open-loop servo-control system. In another embodiment, the controller 100 is a servo controller for a closed-loop servo-control system. In another embodiment, the controller 100 is a servo controller for a cascaded servo-control system, which uses velocity as an inner loop control and torque as an outer loop control.

In one embodiment, the servo drive 104 provides pulse width modulation (PWM) to the electric motor 90. The servo drive 104 increases pulse width to increase the electrical power provided to the electric motor 90. Other arrangements are contemplated.

In one embodiment, the initial command torque value is ramped or changes in power value, such as by increasing in magnitude over time. The torque tool 20 operates as a torque wrench in one embodiment.

In one embodiment, the power connecting jack 52, the power jack 62 and the power connector 56, along with the communication connecting jack 54, the communication jack 66 and the communication connector 60, are replaced by a single coaxial cable having individual connecting jacks on respective ends thereof. The coaxial cable provides power and communication signals from the control unit 70 to the torque tool 20.

In another embodiment, the elements of the control unit 70, including the AC/DC power convertor 110, are integrated into the body 22 of the torque tool 20. Thus, the separate control unit 70 is eliminated.

In one embodiment, the electric torque fastening system 50 is free from a torque sensor for directly sensing or directly measuring torque output by the torque tool 20. Thus, a measured torque value is not necessary or provided to control the torque for the electric torque fastening system 50.

In another embodiment, the torque tool 20 of the electric torque fastening system 50 includes a torque sensor (not shown). The torque sensor is a strain-gauge or other sensor provided with the torque tool 20. Turning to the flow chart of FIG. 5, in this embodiment, torque is determined by a torque sensor (step 204 modification), instead of motor speed. A torque spike is determined (step 208 modification) based on the spike in directly measured torque value. Further, in this embodiment, a target torque value is compared with the actual measured torque value (step 218 modification) and the target torque value is maintained by direct measurement of the torque value and control of power to the electric motor 90. Thus, direct measurement of torque ensures accurate operation of the electric torque fastening system 50. In this embodiment, the target command torque value is adjustable based on the measured torque value.

In another example, the motor speed sensor 88 is a Hall effect sensor.

Thus, embodiments provide, among other things, an arrangement for controlling a torque tool 20 to apply a preset value of torque to a fastener by limiting electrical power applied to an electric motor of the torque tool initially, and eventually ramping the electrical power and thus ramping or increasing the torque applied by the torque tool. Various features and advantages of the invention are set forth in the following claims.

What is claimed is:

1. A method for applying torque for securing a fastener with a torque tool, the method comprising:
determining an initial command torque value for outputting torque to a fastener engaged by the torque tool that is less than a target command torque value;
in response to actuation of the torque tool, operating the torque tool at the initial command torque value;
in response to a spike in torque, increasing from the initial command torque value to a jump command torque value to increase torque output by the torque tool; and
ramping from the jump command torque value toward the target command torque value to increase torque output by the torque tool.

2. The method according to claim 1, wherein a spike in torque is determined by a decrease in motor speed of an electric motor of the torque tool, and the increase from the initial command torque value to the jump command torque value is essentially an instantaneous increase in the command torque value.

3. The method according to claim 2, wherein the essentially instantaneous increase to the jump command torque value is an increase in voltage provided by a controller to a servo drive, and wherein the servo drive controls electrical power provided to the electric motor that outputs torque.

4. The method according to claim 3, the determining of the initial command torque value being determined based on a gearbox size of the torque tool, a power supply value, and a target torque value provided to the controller, the method further including determining 1) the target command torque value, 2) the jump command torque value, and 3) a rate for the ramping from the jump command torque value toward the target command torque value based on the gearbox size of the torque tool, the power supply value, and the target torque value provided to the controller.

5. The method according to claim 2, including providing a control unit having a servo drive, and in response to the decrease in motor speed, the servo drive is configured to receive the jump command torque value from a controller and provide corresponding electrical power to the electric motor.

6. The method according to claim 5, the ramping from the jump command torque value and toward the target command torque value including increasing a voltage from the controller to the servo drive such that the servo drive provides electrical power to the electric motor to increase the torque at a rate of between about 100 foot-pounds/second and about 1000 foot-pounds/second.

7. The method according to claim 1, including receiving a target torque value, an angle of rotation, and number of fasteners to be secured that are entered into a control panel of the torque tool, the target torque value corresponding to the target command torque value.

8. The method according to claim 1, including
upon obtaining the target command torque value after ramping from the jump command torque value, maintaining the target command torque value for a set amount of time, and
discontinuing the target command torque value so long as rotation of a fastener does not occur during at least a portion of the set amount of time.

9. An electric torque fastening system comprising:
a torque tool including an actuator, an electric motor and a motor speed sensor;
a controller for controlling power to the electric motor, the controller configured to
upon actuation of the torque tool by the actuator, provide an initial command torque value for providing power to the electric motor to apply torque to a fastener engaged with the torque tool;
in response to a spike in torque, provide a jump command torque value that is greater than the initial command torque value to increase electrical power to the electric motor and increase torque output by the torque tool; and
subsequently provide a ramping increase from the jump command torque value toward a target command torque value to increase electrical power provided to the electric motor and thus the torque output by the torque tool.

10. The system according to claim 9, including a control unit for providing the power to the electric motor of the torque tool, the control unit including:
the controller; and
a drive for receiving the initial command torque value, the jump command torque value and the target command torque value from the controller, the drive providing electrical power to the electric motor of the torque tool.

11. The system according to claim 10, the control unit further including a power convertor for converting AC power to DC power, and the drive configured to receive DC power from the power convertor and control electrical power provided to the electric motor.

12. The system according to claim 11, wherein the controller comprises a servo controller and the drive comprises a servo drive.

13. The system according to claim 12, further including
a power connector for providing power from the control unit to the electric motor of the torque tool, and
a communication connector for transmitting communication signals between the control unit and the torque tool.

14. The system according to claim 9, wherein the controller is configured to
obtain the initial command torque value, the jump command torque value, the target command torque value, and a ramping rate for the ramping increase from the jump command torque value toward a target command torque value based on a target torque value, a gearbox size for the torque tool, and a supply voltage, and
upon determining that the target command torque value is obtained during ramping, maintain the target command torque value for a set amount of time, and when movement of the electric motor is not detected during at least a portion of the set amount of time, discontinue electrical power to the electric motor of the torque tool to end operation thereof.

15. The system according to claim 9, wherein a spike in torque is determined by the motor speed sensor sensing a decrease in motor speed of the electric motor of the torque tool, and the increase from the initial command torque value to the jump command torque value is an essentially instantaneous increase in the command torque value.

16. The system according to claim 15, wherein the essentially instantaneous increase to the jump command torque value is an increase in voltage provided by the controller to a servo drive that controls electrical power provided to the electric motor.

17. The system according to claim 9, including a control panel for receiving a target torque value, an angle of rotation, and number of fasteners to be secured, the target torque value corresponding to torque output by the torque tool, and
wherein the target command torque value corresponds to the target torque value.

18. The system according to claim 9, wherein the system is free from a torque sensor for sensing torque output by the torque tool.

19. A method for applying torque for securing a fastener with a torque tool, the method comprising:
in response to a target torque value, determining an initial command torque value, a jump command torque value, and a target command torque value;
in response to actuation of the torque tool, operating the torque tool at the initial command torque value;
in response to a spike in torque, essentially instantaneously increasing from the initial command torque value to the jump command torque value to increase torque output by the torque tool; and
ramping from the jump command torque value toward the target command torque value to increase torque output by the torque tool.

20. The method according to claim 19, including determining a ramping rate for ramping from the jump command torque value toward the target command torque value from the target torque value, a gearbox size of the torque tool, and a supply voltage.

21. The method according to claim 19, including sensing a motor speed of an electric motor of the torque tool with an encoder, wherein the spike in torque is determined by a decrease in motor speed of an electric motor of the torque tool as determined by increasing time between pulses generated by the encoder.

22. The method according to claim 21, the sensing of a decrease in the motor speed from the increasing time between pulses generated by the encoder including determining a decrease when at least five consecutive time readings between pulses increase; and at least one from a group consisting of 1) the time between pulses is more than about 1 second, and 2) a speed decrement is 50% less than a maximum speed recorded for the electrical motor.

23. The method according to claim 19, including sensing torque of the torque tool with a torque sensor, wherein the spike in torque is determined from the directly sensed torque.
